(19) United States
(12) Patent Application Publication
(10) Pub. No.: US 2020/0279323 A1
(43) Pub. Date: Sep. 3, 2020

(54) CREDIT CONTRACT PROCESSING METHOD AND APPARATUS

(71) Applicant: ALIBABA GROUP HOLDING LIMITED, Grand Cayman (KY)

(72) Inventor: Jie LI, HANGZHOU (CN)

(21) Appl. No.: 16/875,929

(22) Filed: May 15, 2020

Related U.S. Application Data
(63) Continuation of application No. PCT/CN2020/071990, filed on Jan. 14, 2020.

(30) Foreign Application Priority Data
Jul. 31, 2019 (CN) 201910703171.3

(51) Int. Cl. G06Q 40/02; G06Q 20/24

(52) U.S. Cl. CPC G06Q 40/025; G06Q 20/24

(57) ABSTRACT

A credit contract processing method and apparatus are provided. The credit contract processing method includes: obtaining a participation request submitted by an inviting user for participating in a credit project; determining a credit contract template according to the participation request; generating a contract-initiating document according to the credit contract template and a signing instruction submitted by the inviting user for the credit contract template; inviting a target user to participate in the credit project by transmitting the contract-initiating document to the target user; and generating a credit contract based on the contract-initiating document upon receiving the contract-accepting instruction submitted by the target user for the contract-initiating document. The credit contract processing method protects legitimate interests of participants in the credit project, improves credibility of the credit project, thereby promoting user participation of the credit project and the integrity of the credit system.

### CROSS-REFERENCE TO RELATED APPLICATION

This application is a continuation application of International Patent Application No. PCT/CN2020/071990, filed on Jan. 14, 2020, which is based on and claims priority of the Chinese Patent Application No. 201910703171.3, filed on Jul. 31, 2019. The above-referenced applications are incorporated herein by reference in their entirety.

### TECHNICAL FIELD

This specification relates to the field of data processing technologies, and more specifically, to a credit contract processing method. The specification further relates to a credit contract processing apparatus, a computing device, and a computer-readable storage medium.

### BACKGROUND

With continuous development of Internet technologies, a user's credit is playing an increasingly important role, and the credit infrastructure has been continuously established and improved. Credit platforms that provide users with various credit services, including credit services such as credit leasing, credit borrow, and credit trial, have emerged.

Currently, in a process in which a user uses a credit service provided by a credit platform, a credit closed-loop mode is formed among the user, a merchant on the credit platform who provides the user with article/information lease or borrow, and the user's credit on the credit platform. In this mode, the merchant provides credit data to the credit platform to maintain the user's credit. However, in this mode, credit maintenance on the credit platform only incentivizes one party, namely, the user, and the merchants are not motivated to provide data to the credit platform. Thus, this mode has limitations in that it lacks a mechanism to ensure high-quality credit data.

### SUMMARY

In view of the aforementioned deficiencies, the specification provides a credit contract processing method to address a technical disadvantage in the existing technologies. The specification further provides a credit contract processing apparatus, a computing device, and a computer-readable storage medium.

One aspect of the specification is directed to a credit contract processing method. The method may include: obtaining, by a service-provider computing device, a participation request submitted by an inviting user for participating in a credit project; determining, by the service-provider computing device and according to a project type of the credit project in the participation request, a credit contract template corresponding to the project type; generating, by the service-provider computing device, a contract-initiating document according to the credit contract template and a signing instruction submitted by the inviting user for the credit contract template; inviting a target user to participate in the credit project by transmitting the contract-initiating document to the target user; and generating, upon receiving a contract-accepting instruction submitted by the target user for the contract-initiating document, a credit contract based on the contract-initiating document. The inviting user may serve as a contract-initiating party and the target user who submits the contract-accepting instruction may serve as a contract-accepting party.

In some embodiments, the generating a contract-initiating document according to the credit contract template and a signing instruction submitted by the inviting user for the credit contract template may include: determining a first credit data type related to a contract-initiating condition recorded in the credit contract template; obtaining credit information of the inviting user according to the first credit data type; and generating, in response to the credit information of the inviting user matching the contract-initiating condition, the contract-initiating document based on the credit contract template and the signing instruction. The inviting user may serve as the contract-initiating party and the contract-initiating condition may serve as a contract-initiating clause of the credit project.

In some embodiments, the generating a credit contract based on the contract-initiating document may include: determining a second credit data type related to a contract-accepting condition in the contract-initiating document; obtaining, according to the second credit data type, credit information of the target user; and generating, in response to the credit information of the target user matching the contract-accepting condition, the credit contract based on the contract-initiating document. The inviting user may serve as the contract-initiating party, the target user may serve as the contract-accepting party, the contract-initiating condition may serve as the contract-initiating clause of the credit project, and the contract-accepting condition may serve as a contract-accepting clause of the credit project.

In some embodiments, the aforementioned method may further include: after generating a credit contract based on the contract-initiating document, determining, according to performance event information of one or both of the contract-accepting party and the contract-initiating party for the credit project and a performance clause in the credit contract, performance behaviors of the credit contract for one or both of the contract-accepting party and the contract-initiating party; and determining, according to the performance behaviors and a right-responsibility clause in the credit contract, a credit score generated according to participation of one or both of the contract-accepting party and the contract-initiating party in the credit project.

In some embodiments, the performance clause may include at least one of a project performance time, a project performance event, and a project performance objective.

In some embodiments, the determining performance behaviors of the credit contract for one or both of the contract-accepting party and the contract-initiating party may include: obtaining the performance event information for the credit contract in a process in which one or both of the contract-initiating party and the contract-accepting party participate in the credit project; determining, in response to a performance event in the performance event information that one or both of the contract-initiating party and the contract-accepting party participate in and execute is not empty, whether an execution time of the performance event in the performance event information falls within a time range corresponding to the project performance time; in response to determining that the execution time of the performance event in the performance event information falls within the time range corresponding to the project performance time, determining whether the performance event in the performance event information is consistent with the project performance event, and whether an event execution result of the performance event in the performance event information is consistent with the project performance objective; and, in response to determining that the performance event in the performance event information is consistent with the project performance event, and the event execution result of the performance event in the performance event information is consistent with the project performance objective, determining that the performance behaviors of one or both of the contract-accepting party and the contract-initiating party for the credit contract are successful performance; otherwise, determining that the performance behaviors of one or both of the contract-accepting party and the contract-initiating party for the credit contract is unsuccessful performance.

In some embodiments, the aforementioned method may further include: after obtaining the performance event information for the credit contract in a process in which one or both of the contract-initiating party and the contract-accepting party participate in the credit project, determining, in response to determining that the performance event in the performance event information that one or both of the contract-initiating party and the contract-accepting party participate in and execute is empty, whether a time difference between a current timestamp and the project performance time is less than a preset time threshold; and sending, in response to the time difference between the current timestamp and the project performance time is less than the preset time threshold, a performance reminder of the credit contract to one or both of the contract-initiating party and the contract-accepting party.

In some embodiments, the aforementioned method may further include: after generating, upon receiving a contract-accepting instruction submitted by the target user for the contract-initiating document, a credit contract based on the contract-initiating document, updating, according to the performance behaviors of one or both of the contract-accepting party and the contract-initiating party for the credit contract, a performance status of the credit contract; and synchronizing an updated performance status of the credit contract to the contract-initiating party and the contract-accepting party.

In some embodiments, the inviting, by transmitting the contract-initiating document to a target user, the target user to participate in the credit project may include: transmitting the contract-initiating document to the target user selected by the contract-initiating party, displaying the contract-initiating document on a terminal device of the target user, and displaying, on the terminal device, a contract-accepting trigger control used to submit a contract-accepting instruction for the contract-initiating document. The contract-accepting instruction submitted by the target user for the contract-initiating document may include the contract-accepting instruction submitted by the target user by triggering the contract-accepting trigger control displayed on the terminal device.

Another aspect of the specification is directed to a credit contract processing apparatus. The apparatus may include one or more processors and one or more non-transitory computer-readable memories coupled with the one or more processors and configured with instructions executable by the one or more processors. The instructions may be executed to obtain a participation request submitted by an inviting user for participating in a credit project; determine, according to a project type of the credit project in the participation request, a credit contract template corresponding to the project type; generate a contract-initiating document according to the credit contract template and a signing instruction submitted by the inviting user for the credit contract template; invite a target user to participate in the credit project by transmitting the contract-initiating document to the target user; and generate a credit contract based on the contract-initiating document upon receiving the contract-accepting instruction submitted by the target user for the contract-initiating document. The inviting user may serve as a contract-initiating party and the target user who submits a contract-accepting instruction may serve as a contract-accepting party.

In some embodiments, to generate a contract-initiating document, the one or more non-transitory computer-readable memories of the apparatus may be further configured with instructions executable by the one or more processors to determine a first credit data type related to a contract-initiating condition in the credit contract template; obtain credit information of the inviting user according to the first credit data type; and generate, in response to the credit information of the inviting user matching the contract-initiating condition, the contract-initiating document based on the credit contract template and the signing instruction. The inviting user may serve as the contract-initiating party and the contract-initiating condition may serve as a contract-initiating clause of the credit project.

In some embodiments, to generate a credit contract based on the contract-initiating document, the one or more non-transitory computer-readable memories of the apparatus may be further configured with instructions executable by the one or more processors to determine a second credit data type related to a contract-accepting condition in the contract-initiating document; obtain, according to the second credit data type, credit information of the target user; and generate, in response to the credit information of the target user matching the contract-accepting condition, the credit contract based on the contract-initiating document. The inviting user may serve as the contract-initiating party, the target user may serve as the contract-accepting party, the contract-initiating condition may serve as the contract-initiating clause of the credit project, and the contract-accepting condition may serve as a contract-accepting clause of the credit project.

In some embodiments, the one or more non-transitory computer-readable memories of the apparatus may be further configured with instructions executable by the one or more processors to determine, according to performance event information of one or both of the contract-accepting party and the contract-initiating party for the credit project and a performance clause in the credit contract, performance behaviors of the credit contract for one or both of the contract-accepting party and the contract-initiating party; determine, according to the performance behaviors and a right-responsibility clause in the credit contract, a credit score generated according to participation of one or both of the contract-accepting party and the contract-initiating party in the credit project.

In some embodiments, the performance clause may include at least one of a project performance time, a project performance event, and a project performance objective.

In some embodiments, the one or more non-transitory computer-readable memories of the apparatus may be further configured with instructions executable by the one or more processors to obtain the performance event information for the credit contract in a process in which one or both of the contract-initiating party and the contract-accepting party participate in the credit project; determine, in response to a performance event in the performance event information that one or both of the contract-initiating party and the contract-accepting party participate in and execute is not empty, whether an execution time of the performance event in the performance event information falls within a time range corresponding to the project performance time; in response to determining that the execution time of the performance event in the performance event information falls within the time range corresponding to the project performance time, determine whether the performance event in the performance event information is consistent with the project performance event, and whether an event execution result of the performance event in the performance event information is consistent with the project performance objective; in response to determining that the performance event in the performance event information is consistent with the project performance event, and the event execution result of the performance event in the performance event information is consistent with the project performance objective, determine that the performance behaviors of one or both of the contract-accepting party and the contract-initiating party for the credit contract are successful performance; otherwise, determine that the performance behaviors of one or both of the contract-accepting party and the contract-initiating party for the credit contract is unsuccessful performance.

In some embodiments, the one or more non-transitory computer-readable memories of the apparatus may be further configured with instructions executable by the one or more processors to determine, in response to the performance event in the performance event information that one or both of the contract-initiating party and the contract-accepting party participate in and execute is empty, whether a time difference between a current timestamp and the project performance time is less than a preset time threshold; and send a performance reminder of the credit contract to one or both of the contract-initiating party and the contract-accepting party in response to the time difference between the current timestamp and the project performance time is less than the preset time threshold.

In some embodiments, the one or more non-transitory computer-readable memories of the apparatus may be further configured with instructions executable by the one or more processors to update a performance status of the credit contract according to the performance behaviors of one or both of the contract-accepting party and the contract-initiating party for the credit contract; and synchronize an updated performance status of the credit contract to the contract-initiating party and the contract-accepting party.

In some embodiments, the one or more non-transitory computer-readable memories of the apparatus may be further configured with instructions executable by the one or more processors to transmit the contract-initiating document to the target user selected by the contract-initiating party, display the contract-initiating document on a terminal device of the target user, and display, on the terminal device, a contract-accepting trigger control used to submit a contract-accepting instruction for the contract-initiating document. The contract-accepting instruction submitted by the target user for the contract-initiating document may include the contract-accepting instruction submitted by the target user by triggering the contract-accepting trigger control displayed on the terminal device.

Another aspect of the specification is directed to a non-transitory computer-readable storage medium having instructions stored thereon executable by a processor to cause the processor to perform operations.

The operations may include obtaining a participation request submitted by an inviting user for participating in a credit project; determining, according to a project type of the credit project in the participation request, a credit contract template corresponding to the project type; generating a contract-initiating document according to the credit contract template and a signing instruction submitted by the inviting user for the credit contract template; inviting a target user to participate in the credit project by transmitting the contract-initiating document to the target user; and generating, upon receiving a contract-accepting instruction submitted by the target user for the contract-initiating document, a credit contract based on the contract-initiating document. The inviting user may serve as a contract-initiating party and the target user who submits a contract-accepting instruction serves as a contract-accepting party.

In some embodiment, the generating, according to the credit contract template and a signing instruction submitted by the inviting user for the credit contract template, a contract-initiating document may include: determining a first credit data type related to a contract-initiating condition recorded in the credit contract template; obtaining, according to the first credit data type, credit information of the inviting user; and generating, in response to the credit information of the inviting user matching the contract-initiating condition, the contract-initiating document based on the credit contract template and the signing instruction. The inviting user may serve as the contract-initiating party, and the contract-initiating condition may serve as a contract-initiating clause of the credit project.

According to the credit contract processing method provided in the specification, when the inviting user and the target user confirm their participation in the credit project by using corresponding instructions, the credit contract, in which the inviting user serves as the contract-initiating party and the target user serves as the contract-accepting party, may be formed based on the contract-initiating document generated according to the credit contract template corresponding to the credit project. The behaviors of the contract-initiating party and the contract-accepting party participating in the credit project may be bounded by the credit contract both parties signed, and the legitimate interests of the participating parties in the credit project can be protected. Thus the credibility of the credit project may be improved, thereby promoting user participation of the credit project and the integrity of the credit system.

### BRIEF DESCRIPTION OF THE DRAWINGS

FIG. 1 is a flowchart illustrating a credit contract processing method according to an embodiment of the specification.

FIG. 2 is a flowchart illustrating a credit contract processing method applied to a credit book borrow project according to an embodiment of the specification.

FIG. 3 is a schematic diagram illustrating a credit contract processing apparatus according to an embodiment of the specification.

FIG. 4 is a structural block diagram of a computing device according to an embodiment of the specification.

### DETAIL DESCRIPTION OF THE EMBODIMENTS

Many specific details are described below for a full understanding of the specification. The invention may be implemented in many other ways than those described herein, and those skilled in the art may make similar modifications and changes without departing from the essence of the invention. Therefore, the invention is not limited by the specific implementation disclosed below.

The terms used in one or more embodiments of the specification are merely used to describe the embodiments but are not intended to limit one or more embodiments of the specification. The “a” and “the” in a singular form used in one or more embodiments of the specification and the appended claims are also intended to include a plural form, unless other meanings are clearly indicated in the context. It should also be understood that, the term “and/or” used in one or more embodiments of the specification indicates and includes any or all possible combinations of one or more associated listed items.

It should be understood that although the terms “first,” “second,” and the like may be used to describe various information in one or more embodiments of the specification, but such information should not be limited to these terms. These terms are merely used for distinguishing information of the same type from each other. For example, without departing from the scope of one or more embodiments of the specification, “the first” may also be referred to as “the second.” Similarly, “the second” may also be referred to as “the first.” Depending on the context, the term “if” as used herein may be interpreted as “when . . . ” or “upon . . . ” or “in response to determining.”

First, terms related to one or more embodiments of the specification are explained.

In this specification, “a credit contract” means that two or more participants reach credit consensus on “rights”, “responsibility”, and “interest” for use of a particular service, and each participant who reaches the consensus may keep a piece of data of the reached consensus. For example, a library and a user may reach credit consensus on book borrow, a plurality of users may reach consensus on participating in a public welfare project under a credit constraint, or users may reach consensus on money loan or article borrow under the premise of credit mortgage.

The “right” defines a right enjoyed by one party, and may also be understood as behavior that needs to be performed by the other party, such as returning a borrowed book in an agreed manner, participating a public welfare project in which the other party has promised to participate, or returning borrowed money or object.

The “responsibility” defines a default responsibility that a defaulting party needs to bear. For example, an event of default may be recorded in credit of the defaulting party, a credit rating of the defaulting party may be lowered, or a fine may be imposed on the defaulting party.

The “interest” defines an interest or a reward that a performing party can obtain. For example, a credit rating of a user who successfully returns a borrowed book may be raised through this credit book borrow behavior, a user who successfully participates in a public welfare project according to an agreement can obtain a credit reward, or a user who successfully returns borrowed money or a borrowed article can obtain an amount of money that a defaulting party pays.

The specification provides a credit contract processing method. The specification further provides a credit contract processing apparatus, a computing device, and a computer-readable storage medium. Detailed descriptions are separately provided below with reference to the accompanying drawings of the embodiments provided in the specification, and all steps of the method are described.

A credit contract processing method embodiment provided in the specification is described below.

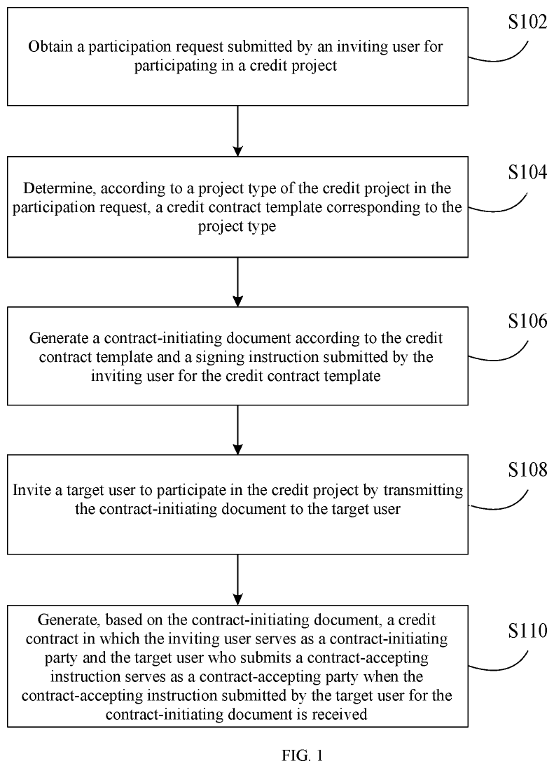

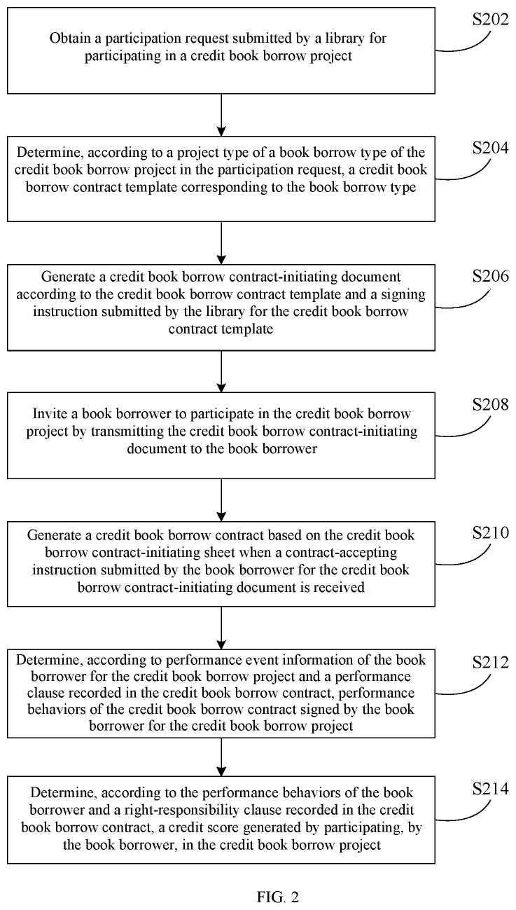

FIG. 1 shows a flowchart illustrating a credit contract processing method according to an embodiment of this specification. FIG. 2 shows a flowchart illustrating a credit contract processing method applied to a credit book borrow project according to an embodiment of this specification.

Referring to FIG. 1, in step S102, a participation request submitted by an inviting user for participating in a credit project may be obtained. The participation request may be obtained by a service-provider computing device.

In this specification, “a credit project” may mean a project involved two or more participants. The participants may reach, in the project, credit consensus on “right”, “responsibility”, and “interest” for use of a service provided in the project or a service provided by a participant of the project (i.e., sign a credit contract), and the project may be referred to as the credit project. The “service-provider computing device” may be any type of stationary or mobile computing device. It may be a local computing device or a remote computing device such as a cloud computing device.

In this embodiment of the specification, a credit book borrow project and a credit public welfare project are used as examples to describe the credit project and a credit contract processing process in the credit project. It should be noted that the credit project in this embodiment of the specification is not limited to the credit book borrow project and the credit public welfare project, and may alternatively be a credit article borrow project, a credit money borrow project, or the like secured by credit. This specification is not limited in this regard.

In the credit book borrow project, a library may serve as a participant for providing a book borrow service, and a book borrower of the library may serve as a participant for using the book borrow service. In a process of book borrow secured by credit of the book borrower in the library, the book borrower may sign a credit contract with the library on this event of book borrow. If the book borrower successfully returns a borrowed book within a book returning period agreed in the credit contract, the library serving as the participant for providing the book borrow service can obtain a specific credit reward. In addition, a credit rating of the book borrower may also be raised through credit book borrow behavior.

In the credit public welfare project, a service may be a public welfare service initiated by a third-party public welfare platform or a credit platform. After a user, as a participant, participates in the public welfare project, the user may sign a credit contract with the third-party public welfare platform or the credit platform as a performing party of the public welfare service, and obtain a corresponding reward by performing and completing the public welfare service agreed upon in the credit contract. For example, for a public welfare activity of walking 10,000 steps every day within half a year initiated by the credit platform, a user who participates in the public welfare activity can obtain a corresponding reward of public welfare points after the public welfare activity is successful completed. If the user who promises to participate in the public welfare activity does not perform the public welfare activity after signing the credit contract, a specific quantity of public welfare points may be deducted for the user as a penalty to the user for his/her default.

Alternatively, the service in the credit public welfare project may be a public welfare service initiated by a user. After another user participates, as a participant, in the public welfare project, the another user may sign a credit contract with the user who initiates the public welfare service, and obtain a corresponding reward by performing and completing the public welfare service agreed upon in the credit contract. For example, for a public welfare activity of three-hour long-distance running in a park on a weekend initiated by a particular user on a public welfare project page of the credit platform, after a sufficient quantity of users participate in and complete the activity, both the user who initiates the public welfare activity and the users who participate in the public welfare activity can obtain corresponding rewards of public welfare points. If the user who promises to participate in the public welfare activity does not perform the public welfare activity after signing the credit contract, a specific quantity of public welfare points may be deducted as a penalty to the user for his/her default.

The inviting user in this embodiment of the specification may be a participant who wants to participate in the credit project and signs the credit contract with another participant on the credit project that is currently participated in. For example, the inviting user in the credit book borrow project may be the library, and the inviting user in the credit public welfare project may be an initiating user or an initiating platform that initiates the public welfare activity.

In step S104, according to a project type of the credit project in the participation request, a credit contract template corresponding to the project type may be determined. The credit contract template may be determined by the service-provider computing device.

In practical application, each industry or service field may have a corresponding service feature. Prerequisites, processes, and results of performing of services in different industries or different service fields may differ, and these factors may play different roles in credit contracts. Herein, to enable the credit contract to more accurately and effectively reflect service features of services in different industries or service fields, this embodiment of the specification provides corresponding credit contract templates for the different industries or service fields.

It should be noted that the credit contract template may record a participation condition for participating in the credit project, and specifically may include a contract-initiating condition for the inviting user (i.e., a condition that the inviting user needs to satisfy to participate in the credit project and sign the credit contract) and a contract-accepting condition for a target user invited by the inviting user to participate in the credit project (i.e., a condition that the target user needs to satisfy to participate in the credit project and sign the credit contract). In addition, the credit contract template may further record a performance clause in a performance process after the credit contract is signed. The performance clause may include a project performance time, a project performance event, and a project performance objective.

During specific implementation, after the participation request submitted by the inviting user for participating in the credit project is obtained, the credit contract template corresponding to the project type may be determined according to the project type of the credit project in the participation request.

For example, in the example of the credit book borrow project, after the library submits a participation request for participating in a thirty-day deposit-free credit book borrow project, according to a project type of the credit book borrow project (e.g., a book borrow type, and a credit book borrow contract template based on a credit contract template corresponding to the book borrow type), it may be determined that a credit contract template corresponding to the credit book borrow project in which the library participates is the credit book borrow contract template.

Specifically, because credit of the library and credit of the book borrower in the credit book borrow project are provided and maintained through the credit platform, a contract-initiating condition recorded in the credit book borrow contract template may be that the library performs credit registration on the credit platform. A contract-accepting condition recorded in the credit book borrow contract template may be that a quantity of credit points of the book borrower on the credit platform is greater than 600, and the book borrower has no negative credit record on the credit platform.

A performance clause recorded in the credit book borrow contract template may include: a performance time is thirty days; a performance event is the returning of a borrowed book; and a performance objective is the returning, within thirty days, of all borrowed books borrowed from the library.

In the example of the credit public welfare project, after a user A submits a participation request for initiating the credit public welfare activity of walking 10,000 steps every day within half a year on the credit public welfare page of the credit platform, according to a project type of the public welfare activity initiated by the user (e.g., a credit public welfare project, and a credit public welfare contract template based on a credit contract template corresponding to the credit public welfare project), it may be determined that a credit contract template corresponding to the public welfare activity of walking 10,000 steps every day within half a year initiated by the user A is the credit public welfare contract template.

Specifically, a contract-initiating condition recorded in the credit public welfare contract template may be that a user A who initiates the credit public welfare activity has participated in and successfully performed a credit public welfare activity. A contract-accepting condition recorded in the credit public welfare contract template may be that a quantity of credit points of a participating user (except the user A who initiates the credit public welfare activity) on the credit platform is greater than 600.

A performance clause recorded in the credit public welfare contract template may include: a performance time is every day within half a year; a performance event is walking 10,000 steps; and a performance objective is the completion of walking 10,000 steps every day within half a year.

In step S106, a contract-initiating document according to the credit contract template and a signing instruction submitted by the inviting user for the credit contract template may be generated. The contract-initiating document may be generated by the service-provider computing device.

To protect rights and interests of the participants in a credit project, improve the credibility of the credit project, and promote user participation of the credit project and the integrity of a credit system, in an optional implementation provided in this embodiment of the specification, generating the contract-initiating document according to the credit contract template and the signing instruction submitted by the inviting user for the credit contract template may be implemented through the following steps.

First, a first credit data type related to the contract-initiating condition recorded in the credit contract template may be determined. Then, according to the first credit data type, credit information of the inviting user may be obtained. If the credit information of the inviting user matches the contract-initiating condition, the contract-initiating document may be generated based on the credit contract template and the signing instruction. The inviting user may serve as a contract-initiating party and the contract-initiating condition may serve as a contract-initiating clause of the credit project.

For example, in the credit book borrow project, the contract-initiating condition recorded in the credit book borrow contract template may be that the library performs the credit registration on the credit platform, and a credit data type related to this contract-initiating condition may be a type of the credit registration. Based on this credit type, whether the library, serving as the inviting user, has completed the credit registration may be inquired on the credit platform, and an inquiry result may be obtained.

If the inquiry result is that the library has not completed the credit registration on the credit platform, it indicates that credit information of the library does not match the contract-initiating condition recorded in the credit book borrow contract template. In other words, the library does not satisfy the contract-initiating condition specified in the credit book borrow contract template, a reminder for the credit registration on the credit platform may be sent to the library.

If the inquiry result is that the library has completed the credit registration on the credit platform, it indicates that credit information of the library matches the contract-initiating condition recorded in the credit book borrow contract template. In other words, the library satisfies the contract-initiating condition specified in the credit book borrow contract template.

When the library satisfies the contract-initiating condition specified in the credit book borrow contract template, a credit book borrow contract-initiating document may be generated according to the credit book borrow contract template and a signing instruction submitted by the library for the credit book borrow contract template, and the generated credit book borrow contract-initiating document may be stored. In a process in which a book borrower borrows a book from the library, the book borrower may be invited to participate in the credit book borrow project by transmitting the stored credit book borrow contract-initiating document to the book borrower.

Herein, the signing instruction submitted by the library for the credit book borrow contract template means that the library confirms the credit book borrow contract template with a signature, and the credit book borrow contract-initiating document may be generated after confirmation with the signature. In other words, the credit book borrow contract template may be changed into the credit book borrow contract-initiating document after the library performs the confirmation with the signature (similar to this, the following credit book borrow contract-initiating document may be changed into a credit book borrow contract after the book borrower performs confirmation with a signature).

For the credit book borrow contract-initiating document, the contract-initiating condition has been satisfied by the library. Therefore, after the library performs the confirmation with the signature, the contract-initiating condition recorded in the credit book borrow contract-initiating document may be understood as a clause that imposes a credit constraint on a contract-initiating process of the library, and the contract-initiating clause may come into effect after the subsequent credit book borrow contract is signed and becomes a contract-initiating clause that has a credit effect and imposes the credit constraint on the contract-initiating process of the library.

In step S108, by transmitting the contract-initiating document to the target user, a target user may be invited to participate in the credit project.

To facilitate the invitation process, improve the interactivity of a process in which the inviting user invites the target user to participate in the credit project, and to promote the participation of the target user in the credit project after an invitation, in an optional implementation provided in this embodiment of the specification, the target user may be invited to participate in the credit project through the following steps.

First, the contract-initiating document may be transmitted to the target user selected by the contract-initiating party. The contract-initiating document may be displayed on a terminal device of the target user, and a contract-accepting trigger control used to submit a contract-accepting instruction for the contract-initiating document may be displayed on the terminal device.

Correspondingly, the following contract-accepting instruction submitted by the target user for the contract-initiating document may refer to the contract-accepting instruction submitted by the target user by triggering the contract-accepting trigger control displayed on the terminal device. Thus, by setting the contract-accepting trigger control, interactivity and convenience of the invitation of the inviting user, and the participation of the target user in the credit project after the invitation, may be improved.

In step S110, upon receiving the contract-accepting instruction submitted by the target user for the contract-initiating document, a credit contract, in which the inviting user serves as a contract-initiating party and the target user who submits a contract-accepting instruction serves as a contract-accepting party may be generated based on the contract-initiating document.

During actual implementation, after the target user is invited to participate in the credit project by transmitting the contract-initiating document to the target user, the target user who receives the invitation may determine whether to participate in the credit project. If the target user who receives the invitation decides not to participate in the credit project, no further processing is required.

If the target user who receives the invitation decides to participate in the credit project, the participation in the credit project may be confirmed by submitting the contract-accepting instruction for the contract-initiating document. Herein, the contract-accepting instruction submitted by the target user for the contract-initiating document may be equivalent to the target user's confirming of the contract-initiating document through a signature.

Upon receiving the contract-accepting instruction submitted by the target user for the contract-initiating document (i.e., the target user confirms the contract-initiating document with the signature), a process of generating the credit contract based on the contract-initiating document may be understood as: based on the contract-initiating document generated after the contract-initiating party confirms the credit contract template with a signature, if the contract-accepting party confirms the contract-initiating document with a signature, the contract-initiating document may be changed into the credit contract having a credit constraint effect, the contract-initiating condition recorded in the credit contract may become a contract-initiating clause having a credit constraint effect, the contract-accepting condition recorded in the credit contract also becomes a contract-accepting clause having a credit constraint effect, and performance clauses of the contract-initiating party and the contract-accepting party recorded in the credit contract may also come into effect.

To further protect rights and interests of the participants in the credit project, improve the credibility of the credit project, and promote user participation of the credit project and the integrity of the credit system, in an optional implementation provided in this embodiment of the specification, generating, based on the contract-initiating document, the credit contract in which the inviting user serves as the contract-initiating party and the target user who submits the contract-accepting instruction serves as the contract-accepting party may be implemented through the following steps.

First, a second credit data type related to the contract-accepting condition recorded in the contract-initiating document may be determined. Then, according to the second credit data type, credit information of the target user who submits the contract-accepting instruction may be obtained. If the credit information of the target user who submits the contract-accepting instruction matches the contract-accepting condition, the credit contract may be generated based on the contract-initiating document. In the credit contract, the inviting user may serve as the contract-initiating party, the target user who submits the contract-accepting instruction may serve as the contract-accepting party, the contract-initiating condition may serve as the contract-initiating clause of the credit project, and the contract-accepting condition may serve as a contract-initiating clause of the credit project.

Continuing with the foregoing example, in the credit book borrow project, the contract-accepting condition recorded in the credit book borrow contract template may be that the quantity of credit points of the book borrower on the credit platform is greater than 600, and the book borrower has no negative credit record on the credit platform.

It can be seen that a credit data type related to the contract-initiating condition is the credit data of the credit platform, a quantity of credit points and a credit record of the book borrower may be obtained from the credit platform based on this credit type.

If the credit point of the book borrower on the credit platform is less than or equal to 600, or the book borrower has a default record on the credit platform, it may indicate that credit information of the book borrower does not match the contract-accepting condition recorded in the credit book borrow contract template. In other words, the book borrower does not satisfy the contract-accepting condition specified in the credit book borrow contract template, and cannot participate in the credit book borrow project as a contract-accepting party.

If the credit point of the book borrower on the credit platform is greater than 600, and the book borrower has no default record, it may indicate that credit information of the book borrower matches the contract-accepting condition recorded in the credit book borrow contract template. In other words, the book borrower satisfies the contract-accepting condition specified in the credit book borrow contract template.

When the book borrower satisfies the contract-accepting condition specified in the credit book borrow contract template, the credit book borrow contract may be generated according to the credit book borrow contract-initiating document and a signing instruction submitted by the book borrower for the credit book borrow contract-initiating document, and the generated credit book borrow contract may be stored for the library and the book borrower, respectively.

Herein, the signing instruction submitted by the book borrower for the credit book borrow contract-initiating document may be equivalent to the book borrower's confirmation of the credit book borrow contract-initiating document with a signature, and the credit book borrow contract may be generated after the confirmation with the signature. In other words, the credit book borrow contract-initiating document that was unilaterally confirmed by the library with the signature now becomes the credit book borrow contract that is confirmed by both the library and the book borrower with signatures to have a credit constraint effect on both parties.

Correspondingly, the contract-initiating condition recorded in the credit book borrow contract may become a contract-initiating clause having a credit constraint effect, and the contract-accepting condition recorded in the credit book borrow contract may also become a contract-accepting clause having a credit constraint effect. The library recorded in the credit book borrow contract may be the contract-initiating party, the book borrower recorded in the credit book borrow contract may be the contract-accepting party, and a performance clause of the book borrower recorded in the credit book borrow contract may come into effect.

As stated above, after the contract-accepting party and the contract-initiating party sign the credit contract, the performance clause recorded in the credit contract may come into effect. Based on this, a credit reward to a successful performing party or credit penalty on a defaulting party (in favor of a successful performing party) may be determined according to actual performance of a performing party recorded in the credit contract with reference to the performance clause. Thus, rights and interests of the participants who participate in the credit project may be maintained. In an optional implementation provided in this embodiment of the specification, after the credit contract is generated based on the contract-initiating document when the contract-accepting instruction submitted by the target user for the contract-initiating document is received, the following performance processing procedure may be performed.

(1). Performance behaviors of the credit contract signed by one or both of the contract-accepting party and the contract-initiating party for the credit project may be determined according to performance event information of one or both of the contract-accepting party and the contract-initiating party for the credit project and the performance clause recorded in the credit contract.

Based on a project performance time, a project performance event, and a project performance objective that are included in the performance clause provided above, the aforementioned performance behaviors of the credit contract may be determined through the following steps (a) through (c).

In step (a), the performance event information for the credit contract may be obtained in a process in which one or both of the contract-initiating party and the contract-accepting party participate in the credit project.

In step (b), when a performance event that is recorded in the performance event information and one or both of the contract-initiating party and the contract-accepting party participate in and execute is not empty, whether an execution time of the performance event recorded in the performance event information falls within a time range corresponding to the project performance time may be determined. If it does, whether the performance event recorded in the performance event information is consistent with the project performance event, and whether an event execution result of the performance event recorded in the performance event information is consistent with the project performance objective, may be determined.

If the performance event recorded in the performance event information is consistent with the project performance event, and the event execution result of the performance event recorded in the performance event information is consistent with the project performance objective, it may be determined that the performance behaviors of one or both of the contract-accepting party and the contract-initiating party for the credit contract are successful performance. Otherwise, if the performance event recorded in the performance event information is inconsistent with the project performance event, or the event execution result of the performance event recorded in the performance event information is inconsistent with the project performance objective, it may be determined that the performance behaviors of one or both of the contract-accepting party and the contract-initiating party for the credit contract is unsuccessful performance.

If the execution time of the performance event recorded in the performance event information does not fall within the time range corresponding to the project performance time, indicating that the performance event that one or both of the contract-initiating party and the contract-accepting party participate in does not occur within the specified performance time range, corresponding reminding information may be sent to one or both of the contract-initiating party and the contract-accepting party who participate in the performance.

In step (c), if the performance event recorded in the performance event information and one or both of the contract-initiating party and the contract-accepting party participate in and execute is empty, whether a time difference between a current timestamp and the project performance time is less than a preset time threshold may be determined. If the time difference between the current timestamp and the project performance time is less than the preset time threshold, a performance reminder of the credit contract may be sent to one or both of the contract-initiating party and the contract-accepting party. Otherwise, if the time difference between the current timestamp and the project performance time is not less than the preset time threshold, no further processing is required.

(2). A credit score generated according to participation of one or both of the contract-accepting party and the contract-initiating party in the credit project may be determined according to the performance behaviors and a right-responsibility clause recorded in the credit contract.

For example, the performance clause recorded in the credit book borrow contract signed by the book borrower and the library for the credit book borrow project may include: a performance time is thirty days; a performance event is the returning of a borrowed book; and a performance objective is the returning, within thirty days, of all borrowed books borrowed from the library.

Meanwhile, a right-responsibility clause recorded in the credit book borrow contract may include: for returning a book according to an agreement, 5 credit points may be awarded; for returning a book after the due date, 1 credit point may be deducted; and for fail to return or damaging a book, 5 credit points may be deducted.

Performance event information (i.e., book returning event information) of the book borrower for the credit book borrow contract signed by the book borrower and the library may first be obtained. If the obtained book returning event information is empty, indicating that the book borrower has not returned a book, whether a time interval between a current time and a book returning deadline is less than three days may be determined. If the time interval between the current time and the book returning deadline is less than three days, a book returning reminder may be sent to the book borrower. If the time interval is more than three days, no further processing is required.

If the obtained book returning event information is not empty, indicating that the book borrower has returned a book, whether a book returning time of the book borrower falls within thirty days specified in the credit book borrow contract may be further determined.

If the book returning time exceeds thirty days, 1 credit point of the book borrower may be deducted. If the book returning time falls within thirty days, whether the book borrower returns all borrowed books and whether a returned borrowed book is damaged may be further determined. If all the borrowed books are returned without damage, 5 credit points may be awarded to the book borrower. If not all the borrowed books are returned or a book is damaged, 5 credit points of the book borrower may be deducted.

Based on the foregoing performance processing, to more timely and effectively convey to the contract-accepting party and the contract-initiating party who sign the credit contract a performance status of the credit contract, in an optional implementation provided in this embodiment of the specification, upon receiving the contract-accepting instruction submitted by the target user for the contract-initiating document, and after the credit book borrow contract, in which the inviting user serves as the contract-initiating party and the target user who submits the contract-accepting instruction serves as the contract-accepting party is generated based on the contract-initiating document, an update and synchronization of the performance status may be implemented through the following steps.

First, a performance status of the credit contract may be updated according to the performance behaviors of one or both of the contract-accepting party and the contract-initiating party for the credit contract.

Then, an updated performance status of the credit contract may be synchronized to the contract-initiating party and the contract-accepting party.

For example, in the credit book borrow project, if the performance behaviors of the book borrower for the credit book borrow contract is that the book has not been returned, the performance status of the credit book borrow contract may be determined to be in performance. If the performance behaviors of the book borrower for the credit book borrow contract is that the book has been returned after the due date, the performance status of the credit book borrow contract may be determined to be delayed performance. If the performance behaviors of the book borrower for the credit book borrow contract is that not all the borrowed books have been returned or that a book is damaged, the performance status of the credit book borrow contract may be determined to be failed performance.

After the performance status of the credit book borrow contract is determined, the performance status may be separately synchronized to the library and the book borrower, so that the library and the book borrower can learn a performance situation of the currently signed credit book borrow contract in a timely and effective manner.

In conclusion, according to the credit contract processing method provided in the specification, when the inviting user and the target user confirm to participate in a credit project by using corresponding instructions, the credit contract, in which the inviting user serves as the contract-initiating party and the target user serves as the contract-accepting party, may be signed based on the contract-initiating document generated according to the credit contract template corresponding to the credit project. By signing the credit contract, the behaviors of the contract-initiating party and the contract-accepting party in a process of participating in the credit project may be bounded, and rights and interests of the participants in the credit project may be protected. Thus, the credibility of the credit project may be improved, thereby promoting user participation of the credit project and the integrity of the credit system.

The credit contract processing method provided in the specification is further described below by using the credit book borrow project as an example. Referring to a credit contract processing method applied to the credit book borrow project provided in FIG. 2, the method may further include step S202 to step S212 described below.

In step S202, a participation request submitted by a library for participating in a credit book borrow project may be obtained.

In the credit book borrow project, the library may serve as a participant for providing a book borrow service, and a book borrower of the library may serve as a participant for using the book borrow service. In a process of book borrow secured by credit of the book borrower in the library, the book borrower may sign a credit contract with the library on this event of book borrow. If the book borrower successfully returns a borrowed book within a book returning period agreed upon in the credit contract, the library serving as the participant for providing the book borrow service can obtain a specific credit reward. In addition, a credit rating of the book borrower may also be raised through the credit book borrow behavior.

In step S204, according to a project type of a book borrow type of the credit book borrow project in the participation request, a credit book borrow contract template corresponding to the book borrow type may be determined.

After the library submits the participation request for participating in a thirty-day deposit-free credit book borrow project, according to a project type of the credit book borrow project (e.g., a book borrow type), a credit contract template corresponding to the book borrow type may be a credit book borrow contract template, a credit contract template corresponding to the credit book borrow project, in which the library participates, may be determined to be the credit book borrow contract template.

Because the credit of the library and the credit of the book borrower in the credit book borrow project may be provided and maintained through a credit platform, a contract-initiating condition recorded in the credit book borrow contract template may be that the library performs credit registration on the credit platform. A contract-accepting condition recorded in the credit book borrow contract template may be that a credit point of the book borrower on the credit platform is greater than 600, and the book borrower has no negative credit record on the credit platform. A performance clause recorded in the credit book borrow contract template may include: a performance time is thirty days; a performance event is the returning of a borrowed book; and a performance objective is the returning, within thirty days, all borrowed books borrowed from the library.

In step S206, a credit book borrow contract-initiating document may be generated according to the credit book borrow contract template and a signing instruction submitted by the library for the credit book borrow contract template.

In the credit book borrow project, the contract-initiating condition recorded in the credit book borrow contract template may be that the library performs the credit registration on the credit platform. It can be seen that a credit data type related to the contract-initiating condition may be the type of the credit registration. Whether the library serving as the inviting user has completed the credit registration may be inquired on the credit platform according to this credit type, and an inquiry result may be obtained.

If the inquiry result is that the library has not completed the credit registration on the credit platform, indicating that credit information of the library does not match the contract-initiating condition recorded in the credit book borrow contract template (i.e., the library does not satisfy the contract-initiating condition specified in the credit book borrow contract template), a reminder for the credit registration on the credit platform may be sent to the library.

If the inquiry result is that the library has completed the credit registration on the credit platform, it may be determined that credit information of the library matches the contract-initiating condition recorded in the credit book borrow contract template (i.e., the library satisfies the contract-initiating condition specified in the credit book borrow contract template).

When the library satisfies the contract-initiating condition specified in the credit book borrow contract template, a credit book borrow contract-initiating document may be generated according to the credit book borrow contract template and a signing instruction submitted by the library for the credit book borrow contract template, and the generated credit book borrow contract-initiating document may be stored. In a process in which the book borrower borrows a book from the library, the book borrower may be invited to participate in the credit book borrow project by transmitting the stored credit book borrow contract-initiating document to the book borrower.

Herein, the signing instruction submitted by the library for the credit book borrow contract template may be equivalent to the library's confirmation of the credit book borrow contract template with a signature, and generating the credit book borrow contract-initiating document after confirmation with the signature. In other words, the credit book borrow contract template may be changed into the credit book borrow contract-initiating document after the library performs the confirmation with the signature (similarly, the following credit book borrow contract-initiating document may be changed into a credit book borrow contract upon the book borrower's confirmation with a signature).

For the credit book borrow contract-initiating document, the contract-initiating condition has been satisfied by the library. Therefore, after the library performs the confirmation with the signature, the contract-initiating condition recorded in the credit book borrow contract-initiating document may be understood as a clause that imposes a credit constraint on a contract-initiating process of the library, and the contract-initiating clause may come into effect after the subsequent credit book borrow contract is signed and becomes a contract-initiating clause that has a credit effect and imposes the credit constraint on the contract-initiating process of the library.

In step S208, by transmitting the credit book borrow contract-initiating document to a book borrower, the book borrower may be invited to participate in the credit book borrow project.

In step S210, upon receiving a contract-accepting instruction submitted by the book borrower for the credit book borrow contract-initiating document, a credit book borrow contract may be generated based on the credit book borrow contract-initiating document.

In the credit book borrow project, the contract-accepting condition recorded in the credit book borrow contract template may be that the credit point of the book borrower on the credit platform is greater than 600, and the book borrower has no negative credit record on the credit platform.

A credit data type related to the contract-initiating condition may be a type of credit data of the credit platform, a credit point and a credit record of the book borrower may be obtained from the credit platform according to this credit type.

If the credit point of the book borrower on the credit platform is less than or equal to 600, or the book borrower has a default record on the credit platform, it may indicate that credit information of the book borrower does not match the contract-accepting condition recorded in the credit book borrow contract template (i.e., the book borrower does not satisfy the contract-accepting condition specified in the credit book borrow contract template, and cannot participate in the credit book borrow project as a contract-accepting party).

If the credit point of the book borrower on the credit platform is greater than 600, and the book borrower has no default record, it may indicate that credit information of the book borrower matches the contract-accepting condition recorded in the credit book borrow contract template (i.e., the book borrower satisfies the contract-accepting condition specified in the credit book borrow contract template).

When the book borrower satisfies the contract-accepting condition specified in the credit book borrow contract template, the credit book borrow contract may be generated according to the credit book borrow contract-initiating document and a signing instruction submitted by the book borrower for the credit book borrow contract-initiating document, and the generated credit book borrow contract may be stored for the library and the book borrower, respectively.

Herein, the signing instruction submitted by the book borrower for the credit book borrow contract-initiating document may mean that the book borrower confirms the credit book borrow contract-initiating document with a signature, and the credit book borrow contract is generated after confirmation with the signature. In other words, the credit book borrow contract-initiating document unilaterally confirmed by the library with the signature may become the credit book borrow contract that has a credit constraint effect and is confirmed by both the library and the book borrower with signatures.

Correspondingly, the contract-initiating condition recorded in the credit book borrow contract may become a contract-initiating clause having a credit constraint effect, and the contract-accepting condition recorded in the credit book borrow contract may become a contract-accepting clause having a credit constraint effect. The library recorded in the credit book borrow contract may be a contract-initiating party, the book borrower recorded in the credit book borrow contract may be the contract-accepting party, and a performance clause of the book borrower recorded in the credit book borrow may come into effect.

In step S212, according to performance event information of the book borrower for the credit book borrow project and a performance clause recorded in the credit book borrow contract, performance behaviors of the credit book borrow contract signed by the book borrower for the credit book borrow project may be determined.

In step S214, according to the performance behaviors of the book borrower and a right-responsibility clause recorded in the credit book borrow contract, a credit score generated according to participation of the credit book borrow project may be determined for the book borrower.

Specifically, the performance clause recorded in the credit book borrow contract signed between the book borrower and the library for the credit book borrow project may include: a performance time is thirty days; a performance event is the returning of a borrowed book; and a performance objective is the returning, within thirty days, of all borrowed books borrowed from the library.

In addition, a right-responsibility clause recorded in the credit book borrow contract may include: for returning a book according to an agreement, 5 credit points may be awarded; for returning a book after the due date, 1 credit point may be deducted; and for fail to return a book or damaging a book, 5 credit points may be deducted.

Performance event information (i.e., book returning event information) of the book borrower for the credit book borrow contract signed by the book borrower and the library may first be obtained. If the obtained book returning event information is empty, indicating that the book borrower has not returned a book, whether a time interval between a current time and a book returning deadline is less than three days may be determined. If the time interval between the current time and the book returning deadline is less than three days, a book returning reminder may be sent to the book borrower. If the time interval between the current time and the book returning deadline is more than three days, no further processing is required.

If the obtained book returning event information is not empty, indicating that the book borrower has returned a book, whether a book returning time of the book borrower falls within thirty days specified in the credit book borrow contract may be further determined. If the book returning time exceeds thirty days, 1 credit point of the book borrower may be deducted. If the book returning time falls within thirty days, whether the book borrower returns all borrowed books and whether a returned borrowed book is damaged may be further determined. If all the borrowed books are returned without damage, 5 credit points may be awarded to the book borrower. Otherwise, if not all the borrowed books are returned or a book is damaged, 5 credit points of the book borrower may be deducted.

A credit contract processing method is provided in the foregoing embodiment. Correspondingly, the specification further provides a credit contract processing apparatus, which is described below with reference to the accompanying drawings.

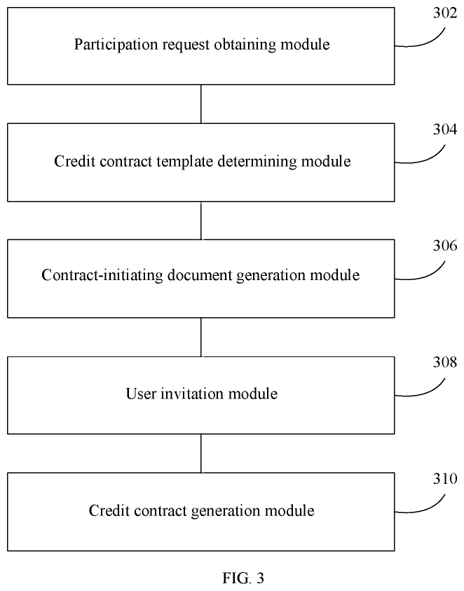

FIG. 3 shows a schematic diagram illustrating a credit contract processing apparatus according to an embodiment of the specification.

An apparatus embodiment is similar to a method embodiment, and therefore, is described briefly. Corresponding descriptions in the method embodiment provided above may be referred to for related parts. The apparatus embodiment described below is merely illustrative.

Referring to FIG. 3, the credit contract processing apparatus of the specification may include a participation request module 302, a credit contract template determining module 304, a contract-initiating document generation module 306, a user invitation module 308, and a credit contract generation module 310.

The participation request obtaining module 302 may be configured to obtain a participation request submitted by an inviting user for participating in a credit project. The credit contract template determining module 304 may be configured to determine, according to a project type of the credit project in the participation request, a credit contract template corresponding to the project type. The contract-initiating document generation module 306 may be configured to generate a contract-initiating document according to the credit contract template and a signing instruction submitted by the inviting user for the credit contract template. The user invitation module 308 may be configured to invite a target user to participate in the credit project by transmitting the contract-initiating document to the target user. The credit contract generation module 310 may be configured to generate, upon receiving the contract-accepting instruction submitted by the target user for the contract-initiating document, a credit contract based on the contract-initiating document. In the credit contract, the inviting user may serve as a contract-initiating party and the target user who submits a contract-accepting instruction may serve as a contract-accepting party.

The contract-initiating document generation module 306 may include a first data type determining submodule, a first credit information obtaining submodule, and a contract-initiating document generation submodule.

The first data type determining submodule may be configured to determine a first credit data type related to a contract-initiating condition recorded in the credit contract template. The first credit information obtaining submodule may be configured to obtain credit information of the inviting user according to the first credit data type. The contract-initiating document generation submodule may be configured to generate the contract-initiating document based on the credit contract template and the signing instruction when the credit information of the inviting user matches the contract-initiating condition. In the contract-initiating document, the inviting user may serve as the contract-initiating party and the contract-initiating condition may serve as a contract-initiating clause of the credit project.

The credit contract generation module 310 may include a second data type determining submodule, a second credit information obtaining submodule, and a credit contract generation submodule.

The second data type determining submodule may be configured to determine a second credit data type related to a contract-accepting condition recorded in the contract-initiating document. The second credit information obtaining submodule may be configured to obtain, according to the second credit data type, credit information of the target user who submits the contract-accepting instruction. The credit contract generation submodule may be configured to generate the credit contract based on the contract-initiating document when the credit information of the target user who submits the contract-accepting instruction matches the contract-accepting condition. In the credit contract, the inviting user may serve as the contract-initiating party, the target user who submits the contract-accepting instruction may serve as the contract-accepting party, the contract-initiating condition may serve as the contract-initiating clause of the credit project, and the contract-accepting condition may serve as a contract-accepting clause of the credit project.

The credit contract processing apparatus may further include a performance behavior determining module and a credit score determining module.

The performance behavior determining module may be configured to determine, according to performance event information of one or both of the contract-accepting party and the contract-initiating party for the credit project and a performance clause recorded in the credit contract, performance behaviors of the credit contract for one or both of the contract-accepting party and the contract-initiating party. The credit score determining module may be configured to determine, according to the performance behaviors and a right-responsibility clause recorded in the credit contract, credit score generated according to participation of one or both of the contract-accepting party and the contract-initiating party in the credit project.

The performance clause may include at least one of a project performance time, a project performance event, and a project performance objective.

The performance behavior determining module may include a performance event information obtaining submodule and a performance event determining submodule.

The performance event information obtaining submodule may be configured to obtain the performance event information for the credit contract in a process in which one or both of the contract-initiating party and the contract-accepting party participate in the credit project.

The performance event determining submodule may be configured to determine, in response to a performance event recorded in the performance event information that one or both of the contract-initiating party and the contract-accepting party participate in and execute and is not empty, whether an execution time of the performance event recorded in the performance event information falls within a time range corresponding to the project performance time; and, if the execution time of the performance event recorded in the performance event information falls within the time range corresponding to the project performance time, launch a project performance objective determining submodule.

The project performance objective determining submodule may be configured to: determine whether the performance event recorded in the performance event information is consistent with the project performance event, and whether an event execution result of the performance event recorded in the performance event information is consistent with the project performance objective; determine, if the performance event recorded in the performance event information is consistent with the project performance event, and the event execution result of the performance event recorded in the performance event information is consistent with the project performance objective, that the performance behaviors of one or both of the contract-accepting party and the contract-initiating party for the credit contract are successful performance; or determine, if the performance event recorded in the performance event information is inconsistent with the project performance event, or the event execution result of the performance event recorded in the performance event information is inconsistent with the project performance objective, that the performance behaviors of one or both of the contract-accepting party and the contract-initiating party for the credit contract is unsuccessful performance.

The performance behavior determining module may further include a performance time determining submodule.

The performance time determining submodule may be configured to: determine, in response to the performance event recorded in the performance event information that one or both of the contract-initiating party and the contract-accepting party participate in and execute is empty, whether a time difference between a current timestamp and the project performance time is less than a preset time threshold; and send, in response to the time difference between the current timestamp and the project performance time is less than the preset time threshold, a performance reminder of the credit contract to one or both of the contract-initiating party and the contract-accepting party.

The credit contract processing apparatus may further include a performance status update module and a performance status synchronization module.

The performance status update module may be configured to update a performance status of the credit contract according to the performance behaviors of one or both of the contract-accepting party and the contract-initiating party for the credit contract. The performance status synchronization module may be configured to synchronize an updated performance status of the credit contract to the contract-initiating party and the contract-accepting party.

The user invitation module 308 may be further configured to: transmit the contract-initiating document to the target user selected by the contract-initiating party, display the contract-initiating document on a terminal device of the target user, and display, on the terminal device, a contract-accepting trigger control used to submit a contract-accepting instruction for the contract-initiating document.

Correspondingly, the contract-accepting instruction submitted by the target user for the contract-initiating document may include the contract-accepting instruction submitted by the target user by triggering the contract-accepting trigger control displayed on the terminal device.

According to the credit contract processing apparatus provided in the specification, when an inviting user and a target user confirm to participate in a credit project by using corresponding instructions, the credit contract, in which the inviting user serves as the contract-initiating party and the target user serves as the contract-accepting party, may be signed based on the contract-initiating document generated according to the credit contract template corresponding to the credit project. By signing the credit contract, the behaviors of the contract-initiating party and the contract-accepting party in a process of participating in the credit project may be bounded, and rights and interests of the participants in the credit project may be protected. Thus, the credibility of the credit project may be improved, thereby promoting user participation of the credit project and the integrity of the credit system.

The specification further provides a computing device, which will be described below.

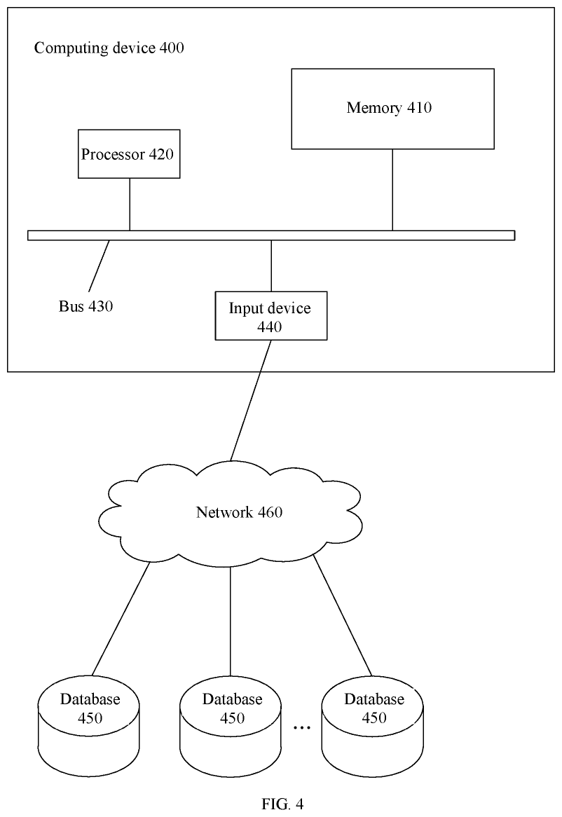

FIG. 4 is a structural block diagram of a computing device 400 according to an embodiment of this specification. Referring to FIG. 4, components of the computing device 400 may include, but are not limited to, a memory 410 and a processor 420. The processor 420 and the memory 410 may be connected to each other through a bus 430. A database 450 may be used to store data.

The computing device 400 may further include an access device 440, and the access device 440 may enable the computing device 400 to communicate through one or more networks 460. Examples of the networks may include a public switched telephone network (PSTN), a local area network (LAN), a wide area network (WAN), a personal area network (PAN), or a combination of communications networks such as the Internet. The access device 440 may include one or more of any type of wired or wireless network interface (e.g., a network interface card (NIC)) such as an IEEE 802.11 wireless local area network (WLAN) wireless interface, a Worldwide Interoperability for Microwave Access (Wi-MAX) interface, an Ethernet interface, a Universal Serial Bus (USB) interface, a cellular network interface, a Bluetooth interface, and a near field communication (NFC) interface.

In an embodiment of this specification, the foregoing components of the computing device 400 and components that are not shown in FIG. 4 may also be connected to each other through, for example, a bus. It should be understood that the structural block diagram of the computing device shown in FIG. 4 is merely used for illustration purposes and is not intended to limit the scope of this specification. A person skilled in the art may add or replace another component according to a requirement.

The computing device 400 may be any type of stationary or mobile computing device, including a mobile computer or a mobile computing device (such as a tablet computer, a personal digital assistant, a laptop computer, a notebook computer, or a netbook), a mobile phone (such as a smartphone), a wearable computing device (such as a smartwatch or smart glasses) or other types of mobile devices, or stationary computing devices such as a desktop computer or a PC. The computing device 400 may be alternatively a mobile or stationary server.

The specification provides a computing device, including the memory 410, the processor 420, and a computer instruction that is stored in the memory and executable on the processor. The processor 420 may be configured to execute the following computer-executable instructions.

The instructions may include: obtaining a participation request submitted by an inviting user for participating in a credit project; determining, according to a project type of the credit project in the participation request, a credit contract template corresponding to the project type; generating a contract-initiating document according to the credit contract template and a signing instruction submitted by the inviting user for the credit contract template; inviting a target user to participate in the credit project by transmitting the contract-initiating document to the target user; and generating, upon receiving the contract-accepting instruction submitted by the target user for the contract-initiating document, a credit contract based on the contract-initiating document. In the credit contract, the inviting user may serve as a contract-initiating party and the target user who submits a contract-accepting instruction may serve as a contract-accepting party.

The generating a contract-initiating document according to the credit contract template and a signing instruction submitted by the inviting user for the credit contract template may include: determining a first credit data type related to a contract-initiating condition recorded in the credit contract template; obtaining credit information of the inviting user according to the first credit data type; and generating, in response to the credit information of the inviting user matching the contract-initiating condition, the contract-initiating document based on the credit contract template and the signing instruction. In the contract-initiating document, the inviting user may serve as the contract-initiating party and the contract-initiating condition may serve as a contract-initiating clause of the credit project.

The generating a credit contract based on the contract-initiating document may include: determining a second credit data type related to a contract-accepting condition recorded in the contract-initiating document; obtaining, according to the second credit data type, credit information of the target user who submits the contract-accepting instruction; and generating, in response to the credit information of the target user who submits the contract-accepting instruction matching the contract-accepting condition, the credit contract based on the contract-initiating document. In the credit contract, the inviting user may serve as the contract-initiating party, the target user who submits the contract-accepting instruction may serve as the contract-accepting party, the contract-initiating condition may serve as the contract-initiating clause of the credit project, and the contract-accepting condition may serve as a contract-accepting clause of the credit project.

After generating a credit contract based on the contract-initiating document, the processor 420 may be further configured to execute the following computer-executable instructions.

These instructions may include determining, according to performance event information of one or both of the contract-accepting party and the contract-initiating party for the credit project and a performance clause recorded in the credit contract, performance behaviors of the credit contract for one or both of the contract-accepting party and the contract-initiating party; and determining, according to the performance behaviors and a right-responsibility clause recorded in the credit contract, credit score generated according to participation of one or both of the contract-accepting party and the contract-initiating party in the credit project.

The performance clause may include at least one of a project performance time, a project performance event, and a project performance objective.

The determining, according to performance event information of one or both of the contract-accepting party and the contract-initiating party for the credit project and a performance clause recorded in the credit contract, performance behaviors of the credit contract for one or both of the contract-accepting party and the contract-initiating party may include: obtaining the performance event information for the credit contract in a process in which one or both of the contract-initiating party and the contract-accepting party participate in the credit project; determining, in response to a performance event recorded in the performance event information that one or both of the contract-initiating party and the contract-accepting party participate in and execute is not empty, whether an execution time of the performance event recorded in the performance event information falls within a time range corresponding to the project performance time; if the execution time of the performance event recorded in the performance event information falls within the time range corresponding to the project performance time, determining whether the performance event recorded in the performance event information is consistent with the project performance event, and whether an event execution result of the performance event recorded in the performance event information is consistent with the project performance objective; and, if the performance event recorded in the performance event information is consistent with the project performance event, and the event execution result of the performance event recorded in the performance event information is consistent with the project performance objective, determining that the performance behaviors of one or both of the contract-accepting party and the contract-initiating party for the credit contract are successful performance; or, if the performance event recorded in the performance event information is inconsistent with the project performance event, or the event execution result of the performance event recorded in the performance event information is inconsistent with the project performance objective, determining that the performance behaviors of one or both of the contract-accepting party and the contract-initiating party for the credit contract is unsuccessful performance.

After obtaining the performance event information for the credit contract in a process in which one or both of the contract-initiating party and the contract-accepting party participate in the credit project, the processor 420 may be further configured to execute the following computer-executable instructions.

These instructions may include determining whether a time difference between a current timestamp and the project performance time is less than a preset time threshold when the performance event recorded in the performance event information that one or both of the contract-initiating party and the contract-accepting party participate in and execute is empty; and sending a performance reminder of the credit contract to one or both of the contract-initiating party and the contract-accepting party if the time difference between the current timestamp and the project performance time is less than the preset time threshold.

After generating, upon receiving the contract-accepting instruction submitted by the target user for the contract-initiating document, a credit contract based on the contract-initiating document, the processor 420 may be further configured to execute the following computer-executable instructions.

These instructions may include updating, according to the performance behaviors of one or both of the contract-accepting party and the contract-initiating party for the credit contract, a performance status of the credit contract; and synchronizing an updated performance status of the credit contract to the contract-initiating party and the contract-accepting party.

The inviting a target user to participate in the credit project by transmitting the contract-initiating document to the target user may include: transmitting the contract-initiating document to the target user selected by the contract-initiating party, displaying the contract-initiating document on a terminal device of the target user, and displaying, on the terminal device, a contract-accepting trigger control used to submit a contract-accepting instruction for the contract-initiating document.

Correspondingly, the contract-accepting instruction submitted by the target user for the contract-initiating document may include the contract-accepting instruction submitted by the target user by triggering the contract-accepting trigger control displayed on the terminal device.

The specification further provides a computer-readable storage medium, which will be described below. The computer-readable storage medium may store a computer instruction. Upon being executed by a processor, the instruction may perform instructions.

The instructions may include: obtaining a participation request submitted by an inviting user for participating in a credit project; determining, according to a project type of the credit project in the participation request, a credit contract template corresponding to the project type; generating a contract-initiating document according to the credit contract template and a signing instruction submitted by the inviting user for the credit contract template; inviting a target user to participate in the credit project by transmitting the contract-initiating document to the target user; and generating, upon receiving the contract-accepting instruction submitted by the target user for the contract-initiating document, a credit contract based on the contract-initiating document. In the credit contract, the inviting user may serve as a contract-initiating party and the target user who submits a contract-accepting instruction may serve as a contract-accepting party.

The generating a contract-initiating document according to the credit contract template and a signing instruction submitted by the inviting user for the credit contract template may include: determining a first credit data type related to a contract-initiating condition recorded in the credit contract template; obtaining credit information of the inviting user according to the first credit data type; and generating, in response to the credit information of the inviting user matching the contract-initiating condition, the contract-initiating document based on the credit contract template and the signing instruction. In the contract-initiating document, the inviting user may serve as the contract-initiating party and the contract-initiating condition may serve as a contract-initiating clause of the credit project.

The generating a credit contract based on the contract-initiating document may include: determining a second credit data type related to a contract-accepting condition recorded in the contract-initiating document; obtaining, according to the second credit data type, credit information of the target user who submits the contract-accepting instruction; and generating, in response to the credit information of the target user who submits the contract-accepting instruction matching the contract-accepting condition, the credit contract based on the contract-initiating document. In the credit contract, the inviting user may serve as the contract-initiating party, the target user who submits the contract-accepting instruction may serve as the contract-accepting party, the contract-initiating condition may serve as the contract-initiating clause of the credit project, and the contract-accepting condition may serve as a contract-accepting clause of the credit project.

After generating a credit contract based on the contract-initiating document, the instructions may include: determining, according to performance event information of one or both of the contract-accepting party and the contract-initiating party for the credit project and a performance clause recorded in the credit contract, performance behaviors of the credit contract for one or both of the contract-accepting party and the contract-initiating party; and determining, according to the performance behaviors and a right-responsibility clause recorded in the credit contract, credit score generated according to participation of one or both of the contract-accepting party and the contract-initiating party in the credit project.

The performance clause may include at least one of a project performance time, a project performance event, and a project performance objective.

The determining, according to performance event information of one or both of the contract-accepting party and the contract-initiating party for the credit project and a performance clause recorded in the credit contract, performance behaviors of the credit contract for one or both of the contract-accepting party and the contract-initiating party may include: obtaining the performance event information for the credit contract in a process in which one or both of the contract-initiating party and the contract-accepting party participate in the credit project; determining, in response to a performance event recorded in the performance event information that one or both of the contract-initiating party and the contract-accepting party participate in and execute is not empty, whether an execution time of the performance event recorded in the performance event information falls within a time range corresponding to the project performance time; if the execution time of the performance event recorded in the performance event information falls within the time range corresponding to the project performance time, determining whether the performance event recorded in the performance event information is consistent with the project performance event, and whether an event execution result of the performance event recorded in the performance event information is consistent with the project performance objective; and, if the performance event recorded in the performance event information is consistent with the project performance event, and the event execution result of the performance event recorded in the performance event information is consistent with the project performance objective, determining that the performance behaviors of one or both of the contract-accepting party and the contract-initiating party for the credit contract are successful performance; or, if the performance event recorded in the performance event information is inconsistent with the project performance event, or the event execution result of the performance event recorded in the performance event information is inconsistent with the project performance objective, determining that the performance behaviors of one or both of the contract-accepting party and the contract-initiating party for the credit contract is unsuccessful performance.

After obtaining the performance event information for the credit contract in a process in which one or both of the contract-initiating party and the contract-accepting party participate in the credit project, the instructions may include: determining whether a time difference between a current timestamp and the project performance time is less than a preset time threshold when the performance event recorded in the performance event information that one or both of the contract-initiating party and the contract-accepting party participate in and execute is empty; and sending a performance reminder of the credit contract to one or both of the contract-initiating party and the contract-accepting party if the time difference between the current timestamp and the project performance time is less than the preset time threshold.

After generating, upon receiving the contract-accepting instruction submitted by the target user for the contract-initiating document, a credit contract based on the contract-initiating document, the instructions may include: updating a performance status of the credit contract according to the performance behaviors of one or both of the contract-accepting party and the contract-initiating party for the credit contract; and synchronizing an updated performance status of the credit contract to the contract-initiating party and the contract-accepting party.

The inviting a target user to participate in the credit project by transmitting the contract-initiating document to the target user may include: transmitting the contract-initiating document to the target user selected by the contract-initiating party, displaying the contract-initiating document on a terminal device of the target user, and displaying, on the terminal device, a contract-accepting trigger control used to submit a contract-accepting instruction for the contract-initiating document.

Correspondingly, the contract-accepting instruction submitted by the target user for the contract-initiating document may include the contract-accepting instruction submitted by the target user by triggering the contract-accepting trigger control displayed on the terminal device.

The foregoing is an exemplary solution of the computer-readable storage medium in this embodiment. It should be noted that the technical solution of the storage medium and the technical solution of the foregoing credit contract processing method have the same concept. For details that are not specifically described in the technical solution of the storage medium, refer to the descriptions of the technical solution of the foregoing credit contract processing method.

The computer instructions include computer program code, and the computer program code may be in a source code form, an object code form, an executable file, or some intermediate forms. The computer-readable medium may include: any entity or device capable of carrying the computer program code, a recording medium, a USB flash drive, a removable hard disk, a magnetic disk, an optical disc, a computer memory, a read-only memory (ROM), a random access memory (RAM), electric carrier signals, telecommunication signals, software distribution media, and the like. It should be noted that, the content contained in the computer-readable medium may be appropriately added or reduced according to the requirements of legislation and patent practice in the jurisdictions. For example, in some jurisdictions, the computer-readable medium does not include electric carrier signals and telecommunication signals.

It should be noted that, for brief description, the foregoing method embodiments are represented as a series of actions. However, persons skilled in the art should appreciate that the specification is not limited to the described order of the actions, because according to the specification, some steps may be performed in other orders or simultaneously. It should be further appreciated by persons skilled in the art that the embodiments described in the specification all belong to preferred embodiments, and the actions and modules are not necessarily required by the specification.

In the foregoing embodiments, the description of each embodiment has respective focuses. For a part that is not described in detail in an embodiment, reference may be made to related descriptions in other embodiments.

The preferred embodiments of the specification disclosed above are only used to help explain the specification. The optional embodiments do not describe all the details, and are not intended to limit the specification to the specific implementations described. Obviously, many modifications and changes may be made according to the content of this specification. These embodiments are selected and described in this specification for better explaining the principles and practical applications of the specification, so that those skilled in the art can better understand and use the specification. This specification is limited only by the claims and full scope and equivalents thereof.

What is claimed is:

1. A credit contract processing method, comprising:
obtaining, by a service-provider computing device, a participation request submitted by an inviting user for participating in a credit project;
determining, by the service-provider computing device and according to a project type of the credit project in the participation request, a credit contract template corresponding to the project type;
generating, by the service-provider computing device and according to the credit contract template and a signing instruction submitted by the inviting user for the credit contract template, a contract-initiating document;
inviting, by transmitting the contract-initiating document to a target user, the target user to participate in the credit project on a terminal device of the target user; and
generating, upon receiving a contract-accepting instruction submitted by the target user for the contract-initiating document from the terminal device of the target user, a credit contract based on the contract-initiating document, wherein the inviting user serves as a contract-initiating party and the target user who submits the contract-accepting instruction serves as a contract-accepting party.

2. The method of claim 1, wherein the generating, by the service-provider computing device and according to the credit contract template and a signing instruction submitted by the inviting user for the credit contract template, a contract-initiating document comprises:
determining a first credit data type related to a contract-initiating condition recorded in the credit contract template;
obtaining, according to the first credit data type, credit information of the inviting user; and
generating, in response to the credit information of the inviting user matching the contract-initiating condition, the contract-initiating document based on the credit contract template and the signing instruction, wherein the inviting user serves as the contract-initiating party and the contract-initiating condition serves as a contract-initiating clause of the credit project.

3. The method of claim 2, wherein the generating a credit contract based on the contract-initiating document comprises:
determining a second credit data type related to a contract-accepting condition in the contract-initiating document;
obtaining, according to the second credit data type, credit information of the target user; and
generating, in response to the credit information of the target user matching the contract-accepting condition, the credit contract based on the contract-initiating document, wherein the inviting user serves as the contract-initiating party, the target user serves as the contract-accepting party, the contract-initiating condition serves as the contract-initiating clause of the credit project, and the contract-accepting condition serves as a contract-accepting clause of the credit project.

4. The method of claim 1, further comprising: after generating the credit contract based on the contract-initiating document,
determining, according to performance event information of one or both of the contract-accepting party and the contract-initiating party for the credit project and a performance clause in the credit contract, performance behaviors of the credit contract for one or both of the contract-accepting party and the contract-initiating party; and
determining, according to the performance behaviors and a right-responsibility clause in the credit contract, a credit score generated according to participation of one or both of the contract-accepting party and the contract-initiating party in the credit project.

5. The method of claim 4, wherein the performance clause comprises at least one of:
a project performance time, a project performance event, and a project performance objective.

6. The method of claim 5, wherein the determining performance behaviors of the credit contract for one or both of the contract-accepting party and the contract-initiating party comprises:
obtaining the performance event information for the credit contract in a process in which one or both of the contract-initiating party and the contract-accepting party participate in the credit project;
determining, in response to a performance event in the performance event information that one or both of the contract-initiating party and the contract-accepting party participate in and execute is not empty, whether an execution time of the performance event in the performance event information falls within a time range corresponding to the project performance time;
determining, in response to determining that the execution time of the performance event in the performance event information falls within the time range corresponding to the project performance time, whether the performance event in the performance event information is consistent with the project performance event, and whether an event execution result of the performance event in the performance event information is consistent with the project performance objective; and
determining, in response to determining that the performance event in the performance event information is consistent with the project performance event, and that the event execution result of the performance event in the performance event information is consistent with the project performance objective, that the performance behaviors of one or both of the contract-accepting party and the contract-initiating party for the credit contract are successful performance; or
determining, in response to determining that the performance event in the performance event information is inconsistent with the project performance event, or that the event execution result of the performance event in the performance event information is inconsistent with the project performance objective, that the performance behaviors of one or both of the contract-accepting party and the contract-initiating party for the credit contract are unsuccessful performance.

7. The method of claim 6, further comprising: after the obtaining the performance event information for the credit contract in a process in which one or both of the contract-initiating party and the contract-accepting party participate in the credit project,
determining, in response to the performance event in the performance event information that one or both of the contract-initiating party and the contract-accepting party participate in and execute is empty, whether a time difference between a current timestamp and the project performance time is less than a preset time threshold; and
sending, in response to the time difference between the current timestamp and the project performance time is less than the preset time threshold, a performance reminder of the credit contract to one or both of the contract-initiating party and the contract-accepting party.

8. The method of claim 7, further comprising: after generating, upon receiving a contract-accepting instruction submitted by the target user for the contract-initiating document, a credit contract based on the contract-initiating document,
updating, according to the performance behaviors of one or both of the contract-accepting party and the contract-initiating party for the credit contract, a performance status of the credit contract; and
synchronizing an updated performance status of the credit contract to the contract-initiating party and the contract-accepting party.

9. The method of claim 1, wherein the inviting, by transmitting the contract-initiating document to a target user, the target user to participate in the credit project comprises:
transmitting the contract-initiating document to the target user selected by the contract-initiating party, displaying the contract-initiating document on a terminal device of the target user, and displaying, on the terminal device, a contract-accepting trigger control used to submit a contract-accepting instruction for the contract-initiating document,
wherein the contract-accepting instruction submitted by the target user for the contract-initiating document comprises the contract-accepting instruction submitted by the target user by triggering the contract-accepting trigger control displayed on the terminal device.

10. A credit contract processing apparatus, comprising one or more processors and one or more non-transitory computer-readable memories coupled to the one or more processors and configured with instructions executable by the one or more processors to:
obtain a participation request submitted by an inviting user for participating in a credit project;
determine, according to a project type of the credit project in the participation request, a credit contract template corresponding to the project type;
generate, according to the credit contract template and a signing instruction submitted by the inviting user for the credit contract template, a contract-initiating document;
invite, by transmitting the contract-initiating document to a target user, the target user to participate in the credit project; and
generate, upon receiving a contract-accepting instruction submitted by the target user for the contract-initiating document, a credit contract based on the contract-initiating document, wherein the inviting user serves as a contract-initiating party and the target user who submits the contract-accepting instruction serves as a contract-accepting party.

11. The apparatus of claim 10, wherein to generate a contract-initiating document, the one or more non-transitory computer-readable memories of the apparatus are further configured with instructions executable by the one or more processors to:
determine a first credit data type related to a contract-initiating condition recorded in the credit contract template;
obtain, according to the first credit data type, credit information of the inviting user; and
generate, in response to the credit information of the inviting user matching the contract-initiating condition, the contract-initiating document based on the credit contract template and the signing instruction, wherein the inviting user serves as the contract-initiating party and the contract-initiating condition serves as a contract-initiating clause of the credit project.

12. The apparatus of claim 11, wherein to generate a credit contract based on the contract-initiating document, the one or more non-transitory computer-readable memories of the apparatus are further configured with instructions executable by the one or more processors to:
determine a second credit data type related to a contract-accepting condition in the contract-initiating document;
obtain, according to the second credit data type, credit information of the target user; and
generate, in response to the credit information of the target user matching the contract-accepting condition, the credit contract based on the contract-initiating document, wherein the inviting user serves as the contract-initiating party, the target user serves as the contract-accepting party, the contract-initiating condition serves as the contract-initiating clause of the credit project, and the contract-accepting condition serves as a contract-accepting clause of the credit project.

13. The apparatus of claim 10, wherein the one or more non-transitory computer-readable memories of the apparatus are further configured with instructions executable by the one or more processors to:
determine, according to performance event information of one or both of the contract-accepting party and the contract-initiating party for the credit project and a performance clause in the credit contract, performance behaviors of the credit contract for one or both of the contract-accepting party and the contract-initiating party; and
determine, according to the performance behaviors and a right-responsibility clause in the credit contract, a credit score generated according to participation of one or both of the contract-accepting party and the contract-initiating party in the credit project.

14. The apparatus of claim 13, wherein the performance clause comprises at least one of:
a project performance time, a project performance event, and a project performance objective.

15. The apparatus of claim 14, wherein the one or more non-transitory computer-readable memories of the apparatus are further configured with instructions executable by the one or more processors to:
obtain the performance event information for the credit contract in a process in which one or both of the contract-initiating party and the contract-accepting party participate in the credit project;
determine, in response to a performance event in the performance event information that one or both of the contract-initiating party and the contract-accepting party participate in and execute is not empty, whether an execution time of the performance event in the performance event information falls within a time range corresponding to the project performance time;
determine, in response to determining that the execution time of the performance event in the performance event information falls within the time range corresponding to the project performance time, whether the performance event in the performance event information is consistent with the project performance event, and whether an event execution result of the performance event in the performance event information is consistent with the project performance objective; and
determine, in response to determining that the performance event in the performance event information is consistent with the project performance event, and the event execution result of the performance event in the performance event information is consistent with the project performance objective, that the performance behaviors of the one or both of the contract-accepting party and the contract-initiating party for the credit contract are successful performance; or
determine, in response to determining that the performance event in the performance event information is inconsistent with the project performance event, or the event execution result of the performance event in the performance event information is inconsistent with the project performance objective, that the performance behaviors of one or both of the contract-accepting party and the contract-initiating party for the credit contract is unsuccessful performance.

16. The apparatus of claim 15, wherein the one or more non-transitory computer-readable memories of the apparatus are further configured with instructions executable by the one or more processors to:
determine, in response to the performance event in the performance event information that one or both of the contract-initiating party and the contract-accepting party participate in and execute is empty, whether a time difference between a current timestamp and the project performance time is less than a preset time threshold; and
send, in response to the time difference between the current timestamp and the project performance time is less than the preset time threshold, a performance reminder of the credit contract to one or both of the contract-initiating party and the contract-accepting party.

17. The apparatus of claim 16, wherein the one or more non-transitory computer-readable memories of the apparatus are further configured with instructions executable by the one or more processors to:
update, according to the performance behaviors of one or both of the contract-accepting party and the contract-initiating party for the credit contract, a performance status of the credit contract; and
synchronize an updated performance status of the credit contract to the contract-initiating party and the contract-accepting party.

18. The apparatus of claim 10, wherein the one or more non-transitory computer-readable memories of the apparatus are further configured with instructions executable by the one or more processors to:
transmit the contract-initiating document to the target user selected by the contract-initiating party, display the contract-initiating document on a terminal device of the target user, and display, on the terminal device, a contract-accepting trigger control used to submit a contract-accepting instruction for the contract-initiating document,
wherein the contract-accepting instruction submitted by the target user for the contract-initiating document comprises the contract-accepting instruction submitted by the target user by triggering the contract-accepting trigger control displayed on the terminal device.

19. A non-transitory computer-readable storage medium having instructions stored thereon executable by a processor to cause the processor to perform operations comprising:
obtaining a participation request submitted by an inviting user for participating in a credit project;
determining, according to a project type of the credit project in the participation request, a credit contract template corresponding to the project type;
generating, according to the credit contract template and a signing instruction submitted by the inviting user for the credit contract template, a contract-initiating document;
inviting, by transmitting the contract-initiating document to a target user, the target user to participate in the credit project; and
generating, upon receiving a contract-accepting instruction submitted by the target user for the contract-initiating document, a credit contract based on the contract-initiating document, wherein the inviting user serves as a contract-initiating party and the target user who submits the contract-accepting instruction serves as a contract-accepting party.

20. The non-transitory computer-readable storage medium of claim 19, wherein the generating, according to the credit contract template and a signing instruction submitted by the inviting user for the credit contract template, a contract-initiating document comprises:
determining a first credit data type related to a contract-initiating condition recorded in the credit contract template;
obtaining, according to the first credit data type, credit information of the inviting user; and
generating, in response to the credit information of the inviting user matching the contract-initiating condition, the contract-initiating document based on the credit contract template and the signing instruction, wherein the inviting user serves as the contract-initiating party and the contract-initiating condition serves as a contract-initiating clause of the credit project.
